(19) United States
(12) Patent Application Publication
(10) Pub. No.: US 2012/0123599 A1
(43) Pub. Date: May 17, 2012

(54) Jet irrigator device

(76) Inventor: Arno Drechsel, Lienz (AT)

(21) Appl. No.: 13/294,744

(22) Filed: Nov. 11, 2011

(30) Foreign Application Priority Data
Nov. 12, 2010 (IT) VI2010A000304

(51) Int. Cl. B05B 12/08; G05D 16/00; G05D 7/00

(52) U.S. Cl. 700/284

(57) ABSTRACT

A jet irrigator for soil (T) irrigation plants includes a launch pipe (2) with an inner tubular conduit (3) having at one end (5′) a nozzle (6) for delivering an irrigation liquid jet (J); rotating support means (4) associated with the launch pipe (2) to allow rotation thereof about a first substantially vertical axis of rotation (X) for brushing at least one sector (S, S′, S″, S′″) of the soil (T) to be irrigated; feeding means (7) for feeding the conduit (3) with a flow having predetermined pressure (P) and flow rate (Q) to deliver a jet (J) having a range (g); first adjustment means (8) for adjusting the feeding pressure (P) to vary the flow rate (Q) and the range (g) of the jet (J) upon rotation of the launch pipe (2), and sensor means (10) for detecting a flow rate value (Q) in said conduit (3) and to transduce it into an electric signal (E) to be sent to the first adjustment means (8).

### FIELD OF THE INVENTION

The present invention generally finds application in the field of irrigation systems for agricultural areas, and particularly relates to a jet irrigator for irrigation plants, particularly a gun irrigator.

### BACKGROUND ART

Gun-type irrigators are known to comprise a launch pipe with an inner conduit which is adapted to be connected to a flow supply line.

The pipe has an end nozzle, which is designed to direct a liquid jet towards a portion of soil to be irrigated, with predetermined flow rate and range, whose values depend both on the liquid supply pressure and on the outlet diameter of the nozzle.

The launch pipe may be also pivotally mounted to a fixed or movable part of the plant to rotate about a substantially vertical axis and irrigate large soil portions.

This type of irrigators is particularly used in large-area irrigation plants, such as center pivot plants, having a load-bearing arm which pivots about a central point to irrigate a circular portion of a generally quadrangular soil area using a plurality of sprinklers.

Particularly, jet irrigators are mounted to the free end of the arm to irrigate the angular sectors of the soil area, i.e. its corners, which are not covered by the arm.

The actuation of the irrigator is controlled for the latter to only operate at such angular sectors, and not to irrigate when the arm is close to the points of tangency of the circle described thereby with the square or rectangle to be irrigated.

The simplest and cheapest method for irrigating angular sectors uses long-range irrigators in which additional pressure is added to the base feeding pressure, using a pressure increasing pump directly connected to the launch pipe, to achieve longer ranges.

The liquid distribution profile depends on the radial distribution profile of the irrigator and on the movement of the entire plant.

In a second method of using long-range irrigators, the latter are mounted to a corner arm, i.e. an articulated irrigation boom fixed to the end of the center pivot arm, to irrigate an angular sector portion of the soil area.

Particularly, the irrigator is mounted to the free end of the corner arm to further increase the irrigable surface.

A first drawback of these prior art solutions is that irrigators have a fixed range.

This involves considerable irrigation liquid waste, since the area to be covered by the jet irrigator is not constant, and varies from a minimum to a maximum as the center arm pivots.

As a result, in the smallest areas of the angular sector to be irrigated, most of the water will fall out of such sector.

A further drawback is that the flow rate and range that can be imparted by the irrigator are determined, for each plant, according to the amount of water and pressure available upstream from the main feeding line, and hence relies on the available pressure and flow rate.

As a result, any pressure and/or flow rate variations may lead to an uneven water distribution to the area irrigated by the irrigator as compared with the area irrigated by the central arm and the corner arm.

This is because the nozzle of the irrigator has a fixed outlet diameter, which does not allow flow distribution to be adapted to particular feed pressure and flow rate conditions.

In such condition, an inadequate or excessive amount of water might be delivered to the irrigated surface, with respect to actual needs.

Therefore, such prior art irrigators are poorly flexible in operation, and their irrigation liquid distribution profiles are not easily adapted to the actual requirements of the soil portion to be irrigated.

An additional drawback of corner arm plants is their high purchase and maintenance cost, and their complex installation, which often makes their use unfeasible.

A further irrigation device that uses long-range irrigators is the so-called waterreel, which has a hose of predetermined diameter and length wound around a turning reel, and a cart at one end with the irrigator mounted thereto.

In operation, the irrigator swings through a predetermined angle about a vertical axis, while the hose is rolled on the reel at a predetermined speed, to deliver a predetermined water amount to the irrigation surface. In this case, the soil area to be irrigated always has a rectangular shape.

Nevertheless, in addition to the flow adjustment problems as mentioned above concerning center pivot plants, these plants cannot irrigate the angular sectors of the soil area and do not allow control of water distribution at the end of the irrigation process, when water is required to be delivered close to the irrigator.

### DISCLOSURE OF THE INVENTION

The object of the present invention is to overcome the above drawbacks, by providing a jet irrigator for irrigation plants that achieves high efficiency and relative cost effectiveness.

A particular object is to provide a jet irrigator for irrigation plants that has high flexibility, to deliver a liquid jet whose flow rate and range can be adjusted according to the particular requirements of each soil portion to be irrigated.

A further object is to provide a jet irrigator for irrigation plants which also affords optimal irrigation of the angular sectors of quadrangular soil areas, and substantially eliminates irrigation liquid wastes.

Yet another object is to provide a jet irrigator for irrigation systems in which the irrigation liquid distribution profile may be dynamically changed.

These and other objects, as more clearly explained hereafter, are fulfilled by a jet irrigator for irrigation plants as defined in claim 1, comprising a launch pipe with an inner tubular conduit having at one end a nozzle for delivering an irrigation liquid jet, rotating support means associated with the launch pipe to allow rotation thereof about a first substantially vertical axis of rotation for brushing at least one sector of the soil to be irrigated; feeding means for feeding the conduit with a liquid flow having predetermined pressure and flow rate to deliver a jet having a range; first adjustment means for adjusting the feeding pressure to vary the flow rate and range of the jet upon rotation of the launch pipe about the first axis.

The irrigator is characterized by comprising sensor means which are designed to detect a flow rate value in said conduit and to transduce this value into an electric signal to be sent to said first adjustment means.

This particular configuration allows dynamic detection of the actual flow rate of the outlet jet, to adjust it in response to special requirements.

Advantageously, second adjustment means may be provided for adjusting the range of the flow delivered by the nozzle according to the distance of the particular portion of the sector to be irrigated from the nozzle.

Preferably, the second adjustment means are designed to change the inclination angle of the launch pipe.

Conveniently, in addition to or instead of the second adjustment means, third adjustment means may be provided for adjusting the flow rate from the nozzle.

In further possible embodiments, the irrigator may also only have one of the first, second and third adjustment means, or may only comprise the second and third adjustment means and not the first adjustment means.

Advantageous embodiments of the invention are defined in accordance with the dependent claims.

### BRIEF DESCRIPTION OF THE DRAWINGS

Further characteristics and advantages of the invention will become more apparent upon reading of the detailed description of a few preferred, non-exclusive embodiments of a jet irrigator of the invention, which are described as non-limiting examples with the help with the accompanying drawings in which:

FIG. 1 is a perspective view of an irrigator of the invention in a first preferred configuration and in a first operating state;

FIG. 2 is a side view of the irrigator of FIG. 1;

FIG. 3 is a side view of the irrigator of FIG. 1 in a second operating state;

FIG. 4 is a side view of a detail of the irrigator of FIG. 1 in the first operating state;

FIG. 5 is a side view of the detail of FIG. 4 in a position corresponding to the second operating state of the irrigator;

FIG. 6 is a perspective view of an irrigator of the invention in a second preferred embodiment;

FIG. 7 is a perspective view of an irrigator of the invention in a third preferred embodiment;

FIG. 8 is a side view of the irrigator of FIG. 7;

FIG. 9 is a partially broken-away side view of a second detail of an irrigator of the invention in a first operating state;

FIG. 10 is a partially broken-away side view of the detail of FIG. 9 in a second operating state;

FIG. 11 is a diagrammatic view of a soil area adapted to be irrigated by an irrigation plant having an irrigator according to the invention.

### DETAILED DESCRIPTION OF A PREFERRED EMBODIMENT

Referring to the accompanying figures, the jet irrigator if the invention, generally designated by numeral 1, may be used in any known irrigation plant, not shown, possibly an existing plant not specially designed for operation with such irrigator 1.

Particularly, the irrigator 1 of the invention may be associated with the pivoting arm of a center pivot system, which is known to be equipped with a plurality of sprinkler-type irrigators or the like.

In this case, the irrigator 1 may be mounted to the free end of the pivoting arm, in either pivoting or fixed fashion.

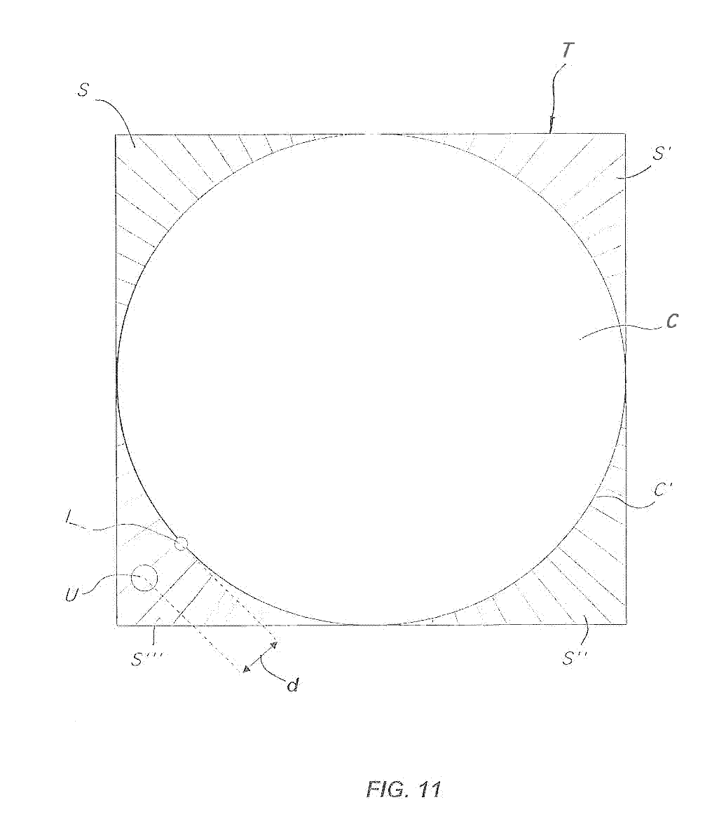

Thus, as schematically shown in FIG. 11, the arm of the center pivot will irrigate a substantially circular portion C of a substantially quadrangular, e.g. square, soil area, by following a circular path C′.

The irrigator 1, which is shown in simple schematic view, is placed on the circular path C′ to only irrigate the circular sectors S, S′, S″, S′″ that the arm cannot cover, which are designated by hatching.

Likewise, the irrigator 1 may be associated with a center pivot plant with a corner arm. Particularly, the irrigator 1 may be pivotally mounted to the free end of the irrigation boom articulated to the central arm of the center pivot.

Finally, the irrigator 1 is also suitable for use in waterreel plants. In this case, it will preferably designed to oscillate about a vertical axis.

An irrigator 1 of the invention essentially comprises a launch pipe 2 which defines a longitudinal extension axis L and has an inner tubular conduit 3 for delivering an irrigation liquid jet.

As is known per se, the launch pipe 2 allows passage of a flow of irrigation liquid therein, to be directed to the soil to be irrigated by a long-range jet J.

Rotating support means 4 are also provided, which are or may be associated to the launch pipe 2 to allow rotation thereof about a first substantially vertical axis of rotation X for brushing at least one sector S of the soil T to be irrigated.

The launch pipe 2 also has a first axial end 50 with a nozzle 6 for delivering the jet J.

Furthermore, the launch pipe 2 may be arranged to be connected in a known manner via the support means 4 at a second end 5″ to a liquid feeding line of the plant, not shown.

The second end 5″ of the pipe 2 is designed to be fastened to a fixed or movable part of the irrigation plant, e.g. the pivoting arm of a center pivot plant.

Furthermore, the launch pipe 2 may be designed to rotate about a first substantially vertical axis of rotation X to direct the jet K to the angular sectors S, S′, S″, S′″ of a soil area T to be irrigated.

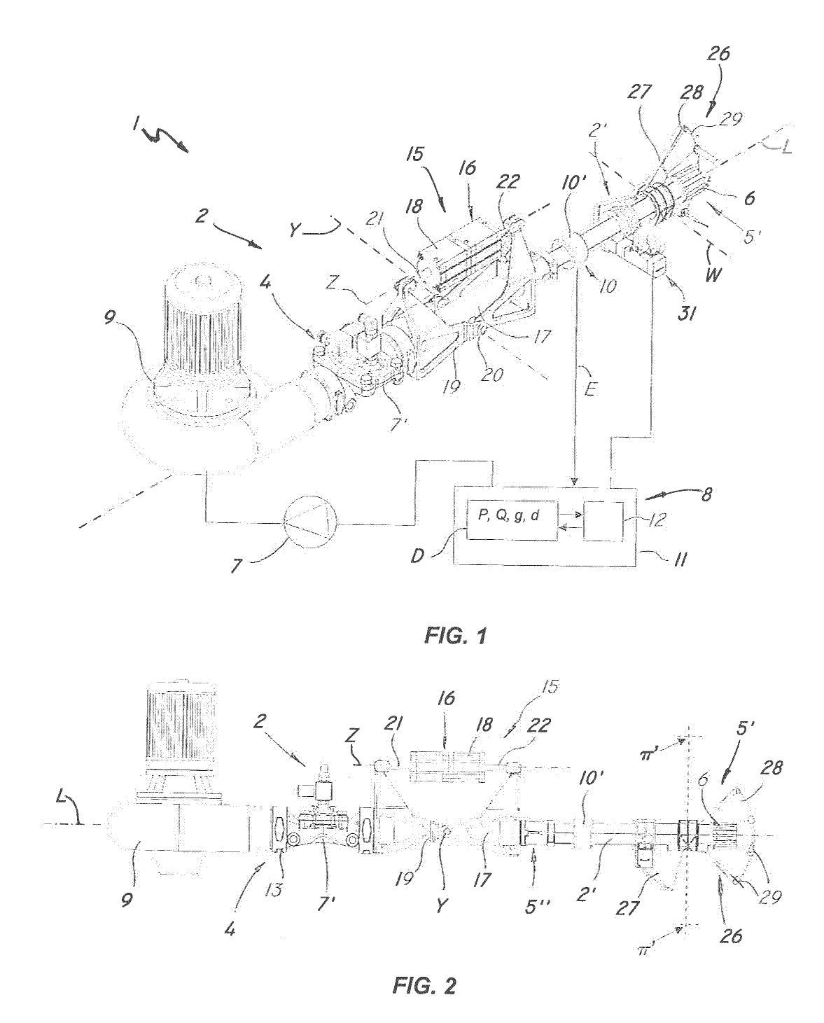

Particularly, if the launch pipe 2 is fixedly mounted to the plant, like in the configurations of FIG. 1 and FIG. 6, e.g. in a center pivot plant, the first vertical axis of rotation X will coincide with the axis of rotation of the pivoting arm of the center pivot.

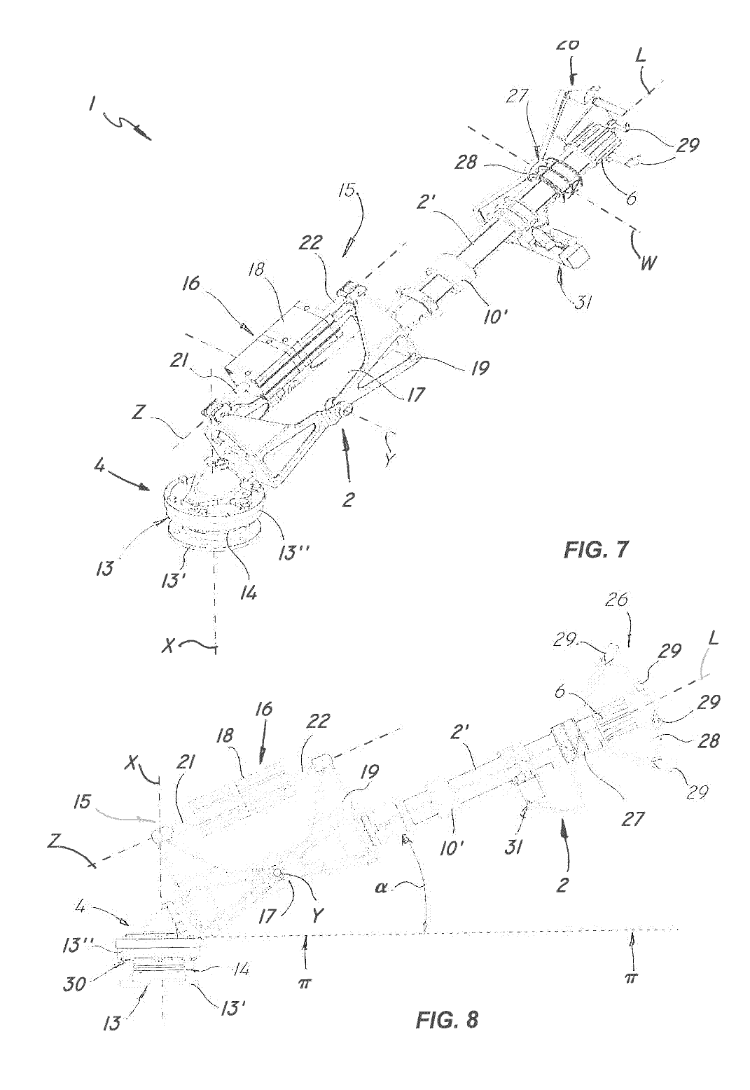

However, in particular applications, e.g. in plants having a corner arm or in waterreels, the launch pipe 2 may be pivotally mounted to the plant, as shown in FIG. 7, to rotate about a first vertical axis X that extends through the support means 4.

In this case, the launch pipe 2 may be moved with a first rotary or oscillatory movement about the first axis of rotation X and with a second rotary movement about the central axis of the system, the two rotational movements being possibly coordinated.

Means 7 are also provided, as schematically shown in the figures, for feeding the conduit 3 with a liquid flow having a predetermined pressure P for delivering a jet J having a flow rate Q and a range g.

The irrigator 1 also comprises first adjustment means 8 for adjusting the pressure P of the flow being fed to vary the flow rate Q and the range g of the jet J upon rotation of the launch pipe 2 about the first axis X.

The first adjustment means 8 may be directly associated with the feeding means 7 to act thereupon and provide the required change in the flow feeding pressure P.

In a first preferred embodiment, both the first adjustment means 8 and the feeding means 7 may be directly connected to the feeding line of the plant to manage the pressure P and flow rate Q of the flow upstream from the conduit 3 or the entire feeding line.

Alternatively, the first adjustment means 8 may be at least partially directly associated with the conduit 3 of the launch pipe 2.

For example, in a possible embodiment, as shown in FIG. 1, the first adjustment means 8 may comprise a booster pump 9, to apply an extra pressure P′ to the flow, in addition to the feeding pressure P regulated by the main plant.

The pump 9 is directly connected to the first end 4 of the launch pipe 3 to only cause the increase of pressure P within the conduit 3.

In a particularly advantageous configuration, the feeding means 7 may comprise valve means 7′ for shutting off and selectively and alternately delivering the flow in cyclic fashion and with an adjustable, possibly pulsed frequency.

This will provide a long range g while maintaining limited flow delivery.

According to a peculiar feature of the invention, the irrigator 1 also comprises sensor means 10 which are configured for dynamic detection of the flow rate value Q in the conduit 3.

Such detected flow rate value will substantially correspond to the flow rate Q of the jet J delivered by the nozzle 6.

The sensor means 10 are also adapted to transduce such detected flow rate value Q into an electric signal E and to send the latter to the first adjustment means 8.

Thus, the latter may check the actual flow rate Q of the outflowing jet J, determine whether it is appropriate for the irrigation liquid distribution requirements of the particular portion U of soil T to be irrigated, and possibly act upon the feeding means 7.

Advantageously, the first adjustment means 8 may comprise a programmable logic unit 11 having a memory circuit 12 for storing data D about the characteristics of the angular sector S, S′, S″, S′″ to be irrigated, and the flow rate Q to be delivered for each portion U of sector S, S′, S″, S′″.

The term “characteristics of the angular sector” is intended to designate any information in the group comprising geometric shape, surface area, soil properties, crop type.

Particularly, the pressure P and flow rate Q values of the jet J to be delivered may be related to the average distance d of each portion U of sector S, S′, S″, S′″ from the delivery nozzle 6.

As used herein, the term portion U of angular sector S, S′, S″, S′″ is intended to designate a portion of the angular sector S, S′, S″, S′″ whose surface area is equal to the area that can be irrigated by a jet J in a unit of time.

The sensor means 10 may include any commonly available flow sensor, without any particular limitation.

For example, the sensor means 10 may include a sensor 10′ located in any portion of the launch pipe 2, either proximate to or remote from the nozzle 6, either external to the pipe 2 or integrated therein.

The first adjustment means 8 are designed to receive the electric signal E indicative of the flow rate W delivered by the nozzle 6 and detected by the sensor means 10.

Furthermore, they are also configured to control the feeding means 7 so that they can feed the conduit 3 with a flow whose flow rate P and range g substantially match the flow rate P and distance d values of the portion U of sector S, S′, S″, S′″ to be irrigated.

Generally, the launch pipe 2 has at least one end portion 2′ inclined to a substantially horizontal plane π with a predetermined inclination angle α.

For example, the support means 4 may comprise an anchor flange 13 for securing the pipe 2 to the fixed or movable part of the irrigation plant.

The flange 13 may be fixed, like in FIG. 6, or may include a fixed portion 13′ adapted to be secured to the plant and a rotatable portion 13″ rotating relative to the fixed portion, possibly with bearing means 14 interposed therebetween, and associated with first motor means 30, e.g. of the stepper type, for controlled rotation of the pipe 2 about the first axis X, as shown in FIG. 7.

If the irrigator 1 is designed for waterreel plants, then the flange 13 may be supported by a bearing, not shown, which allows rotation of the irrigator 1 about the first vertical axis X.

Furthermore, as mentioned above, the end portion 2′ of the pipe 2 may be hinged to the flange 13 to rotate about a second substantially horizontal axis of rotation Y.

This allows adjustment of the inclination angle α or lift of the launch pipe 2, and the range g of the jet J.

The inclination angle α may be adjusted within any range of values.

Preferably, the inclination angle α may fall in a range from 0° to 45°, more preferably from 0° to 30°.

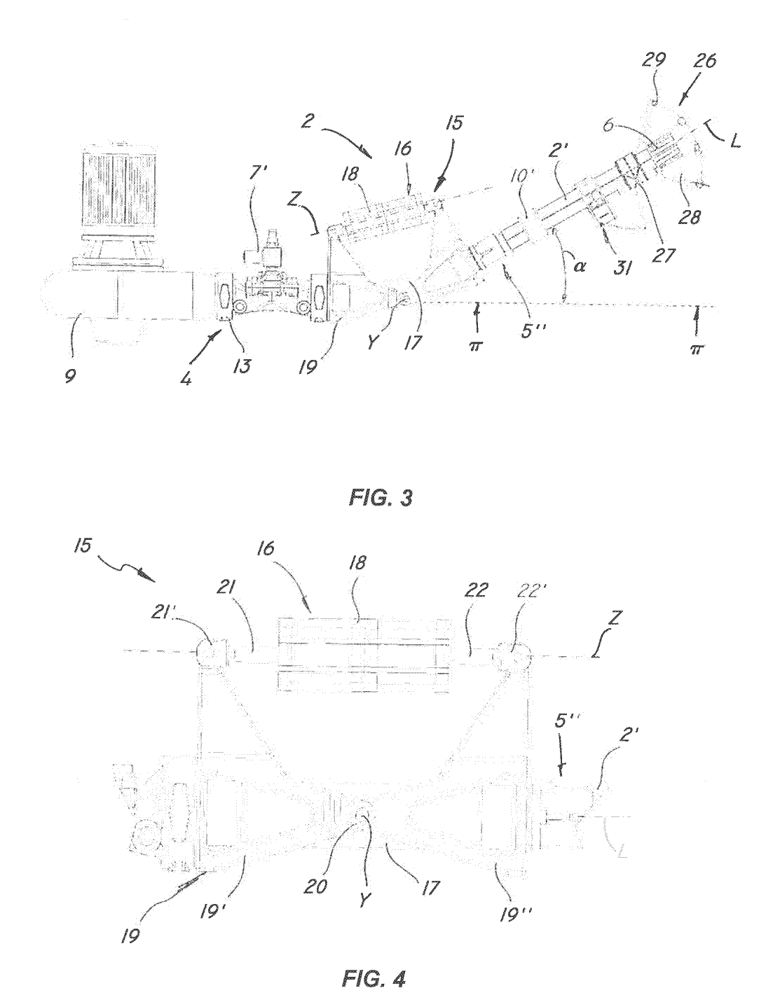

FIGS. 2 and 3 show the irrigator 1 in two limit operating states, corresponding to inclination angles α of 0° and 30° respectively.

In a particularly advantageous aspect, the irrigator 1 comprises second adjustment means 15 for adjusting the range g of the jet J delivered by the nozzle 6.

The second adjustment means 15 are operably connected to the central unit 11 for adjusting the range g according to the distance d of the portion U of angular sector S, S′, S″, S″ to be irrigated.

Preferably, the second adjustment means 15 are designed to change the inclination angle α of the launch pipe 2.

Particularly, the second adjustment means 15 are actuated to progressively increase the inclination angle α with increasing range g and flow rate Q values.

Advantageously, the second adjustment means 15 may be directly associated with the launch pipe 2 to promote rotation thereof about the second axis of rotation Y.

Preferably, the second adjustment means 15 may include a motorized actuator 16 connected to the central unit 11 and adapted to act upon the launch pipe 2 near its second end 5″.

The launch pipe 2 may comprise a flexible tubular section 17 defining an end section thereof, which connects the inclined end portion 2′ to the anchor flange 13.

This particular configuration allows the launch pipe 2 to rotate about the second axis Y without locally deforming or throttling the conduit 3.

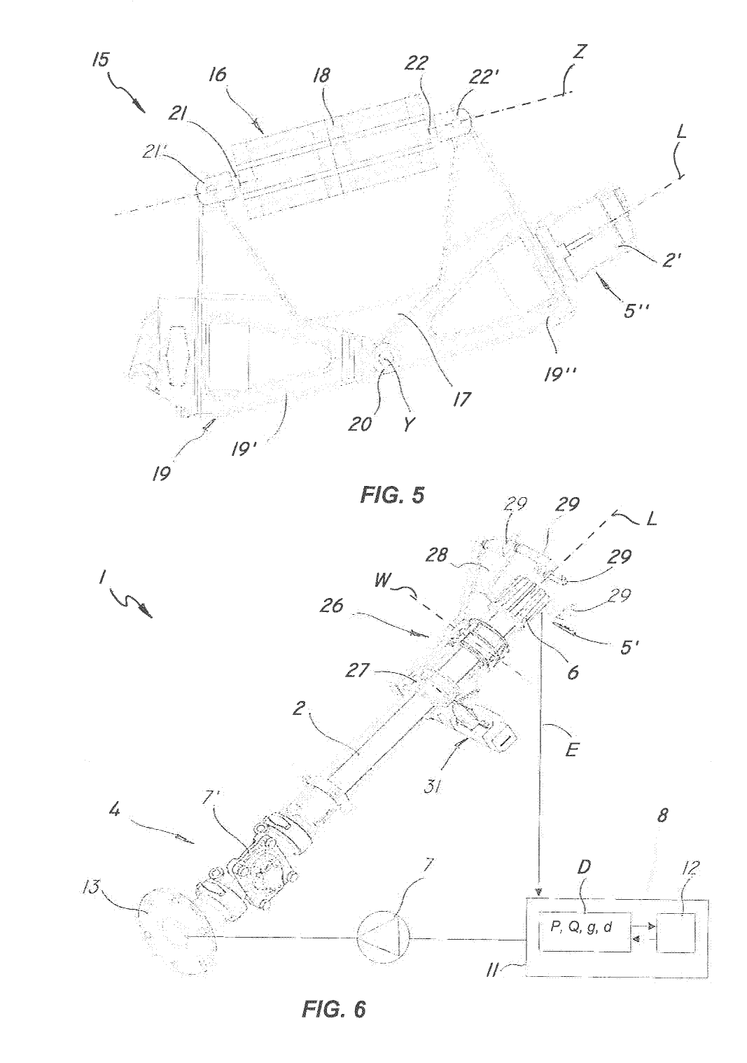

In a preferred, non-limiting embodiment of the invention, as more clearly shown in FIGS. 4 to 5, the actuator 16 is of linear type and operates along a main axis Z in axially sliding fashion.

Particularly, the actuator 16 has an axial end 16′ which is fixedly connected to the anchor flange 13 and an axial end 16″ which is movable relative to the flange 13 and is connected to the launch pipe 2.

The flexible section 17 of the launch pipe 2 extends from the fixed end 16′ to the movable end 16″ of the actuator 16.

Thus, any axial sliding motion of the actuator 16 or a portion thereof will cause a given rotation of the portion 2′ the launch pipe 2 about the second axis of rotation Y, which is substantially horizontal.

In one exemplary embodiment, the actuator 16 may comprise an outer casing 18 which is secured both to the flange 13 and to the launch pipe 2 via a support bracket 19.

The bracket 19 has two portions 19′, 19″ which are mutually pivotally coupled to rotate about a common hinge 20 whose axis defines the second axis of rotation Y.

The flexible section 17 of the launch pipe 2 is confined within the bracket 19.

The casing 18 accommodates at least one cylinder 21 having one end 21′ integral to one of the portions 19′ of the bracket and another end adapted to slide within the casing 18.

Thus, as the cylinder 21 slides, it causes relative rotation of the two portions 19′, 19″ of the bracket 19 and, as a result, rotation of the launch pipe 2 about the hinge 20.

In the particular embodiment of the figures, the actuator 16 comprises two cylinders 21, 22 held within the casing 18 in coaxial and opposed positions and having respective ends 21′, 22′ external to the casing 18 and connected to respective bracket portions 19′, 19″.

Each of the cylinders 21, 22 may be separately actuated to cause rotation of the launch pipe 2 within respective sub-ranges of inclination angle α values.

It shall be understood that the above described solution concerning the second adjustment means 15 is merely an example, and that the actuator 16 may be replaced by any other actuator adapted to transfer a rotational motion to the launch pipe

Furthermore, according to an embodiment that is not shown herein, the second adjustment means 15 may also be manually operated.

Particularly, they will have a first portion designed to be held and moved by a user and a second portion connected to the first portion and acting upon the launch pipe 2 to transfer the motion of the first portion thereto and hence causing rotation thereof about second axis Y.

In yet another aspect of the invention, the irrigator 1 may have third adjustment means 23 for adjusting the flow rate Q delivered by the nozzle 6.

The third adjustment means 23 may be implemented on the irrigator 1 with or without the second means 15 and possibly also without the first means 8.

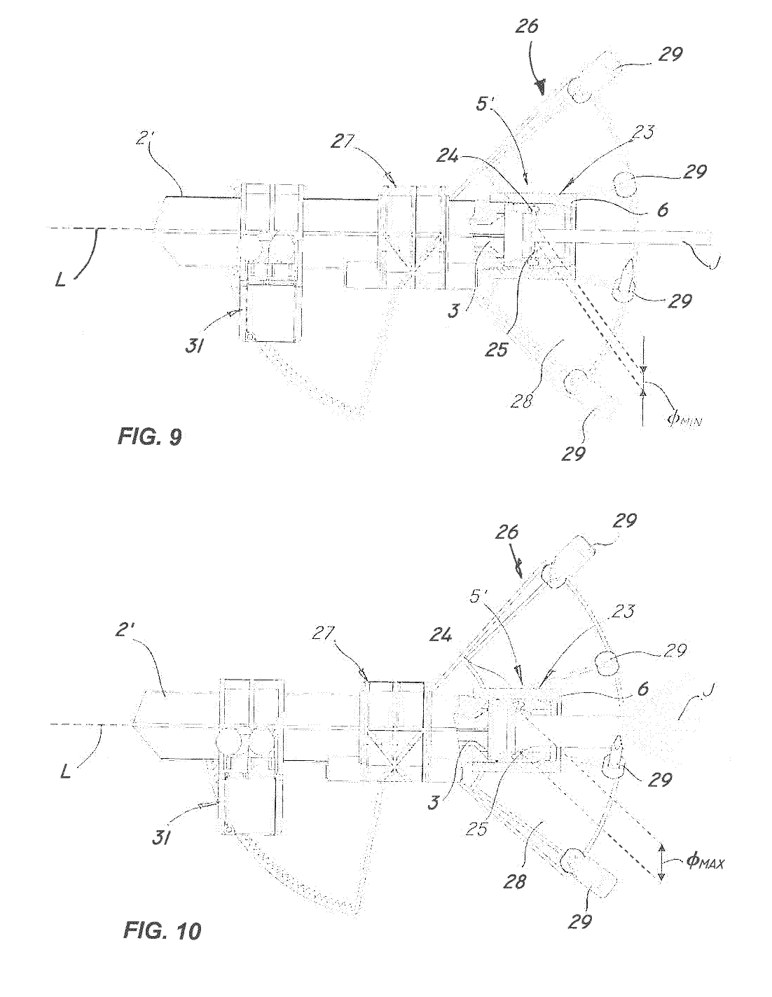

In a preferred embodiment, more clearly shown in FIGS. 9 and 10, the third adjustment means 15 are directly associated with the nozzle 6.

Particularly, the third means 23 are defined by an annular wall 24 of the nozzle 6.

Conveniently, the annular wall 24 has at least one elastically yielding portion 25 which is designed to automatically and progressively deform in response to changing pressure P, and to accordingly change the outlet diameter of the nozzle 6.

Preferably, the annular wall 24 of the nozzle 6 is at least partially, preferably entirely formed of an elastomeric material, such that it can move from a first undeformed configuration, as shown in FIG. 9, corresponding to a minimum or zero pressure P, to a maximum deformed configuration, as shown in FIG. 10, corresponding to the maximum pressure P, and vice versa.

As a result, the inner outlet diameter of the nozzle 6 with change from a minimum value MIN to a maximum value MAX corresponding to minimum and maximum deformations respectively of the yielding portion 25 of the annular wall 24.

Thus, the flow rate Q will also change from a minimum value to a maximum value, corresponding to the minimum and maximum outlet diameter values respectively.

Upon adjustment of the flow rate Q the range g of the jet J may be also adjusted using a single nozzle 6 having of variable diameter

According to yet another particularly advantageous aspect, the irrigator 1 may be equipped with a jet-breaker device 26 mounted to the launch pipe 2 in fixed or removable fashion, to interfere with the jet J and distributed to the soil.

The device 26 comprises a support frame 27 having an end portion 28 which axially projects out of the nozzle 6 and has at least one transversely projecting jet-breaking element 29.

Particularly, the device 26 may include second motor means 31, which are associated with the frame 27 to cause rotation of the end portion 28 about a third transverse axis W orthogonal to the longitudinal axis L of the pipe.

Thus, the jet-breaking element 29 may oscillate with a predetermined variable frequency in an oscillation plane ′ between a position substantially aligned with the nozzle 6 and a position offset from the nozzle 6.

Particularly, in the aligned position, the jet-breaking element 29 may interfere with the jet to partially break it in controlled fashion and cause sprinkling thereof.

On the other hand, in the disaligned position, it will not interfere with the jet J, which may be directed to the soil T in an undistributed fashion.

The portion 28 may be also equipped with a plurality of jet-breaking element 29, which can be selectively placed before the nozzle 6 to interfere with its jet.

The jet-breaking elements 29 have different shapes, to define different distribution profiles of the liquid jet J.

Selective placement of the particular jet-breaking element 29 may be achieved by appropriate rotation of the frame 27 about the third axis W.

One or more of the jet-breaking elements 29 may be starters which, upon interaction with the jet J and as a result of the deflection thereof, will cause a radial reaction, for controlled rotation of the launch pipe 2 about the vertical axis of rotation X.

This configuration will be particularly suitable for irrigators 1 designed for use in waterreels, in which the radial reaction will cause rotation of the launch pipe 2 about the anchor bearing.

In a further aspect, if the irrigator 1 is pivotally mounted to the part of the plant to which it is secured, like in center pivot plants with a corner arm or in waterreels, a position sensor may be also provided, such as an encoder, not shown, which is adapted to detect the angular position of the launch pipe 2 relative to the first axis of rotation X.

The above disclosure clearly shows that the invention fulfills the intended objects, and particularly meets the requirement of providing a jet irrigator for irrigation plants that allows the characteristics of the delivered flow to be adapted to the particular requirements of each soil portion to be irrigated, in highly flexible, dynamic fashion.

Particularly, the provision of the sensor means 10 allows immediate dynamic detection of the parameters of the delivered flow, thereby allowing adjustment thereof without requiring any plant shut-down for reconfiguration, e.g. for replacing the nozzle 6 with another nozzle having a different outlet diameter

Furthermore, in the fullest configuration, including the first 8, second 15 and third 23 adjustment means 23, the irrigator 1 allows pressure P, range g and flow rate Q values to be simultaneously controlled and adjusted within respective ranges, that can be normally obtained from multiple irrigators having different characteristics.

Also, the possibility of adjusting the range f prevents the jet J from being projected out of the angular sector S of the soil area, thereby avoiding water waste.

The irrigator of the invention is susceptible to a number of changes and variants, within the inventive principle disclosed in the appended claims. All the details thereof may be replaced by other technically equivalent parts, and the materials may vary depending on different needs, without departure from the scope of the invention.

While the irrigator has been described with particular reference to the accompanying figures, the numerals referred to in the disclosure and claims are only used for the sake of a better intelligibility of the invention and shall not be intended to limit the claimed scope in any manner.

The invention claimed is:

1. A jet irrigator for soil (T) irrigation systems comprising:
a launch pipe (2) with an inner tubular conduit (3) having at one end (5′) a nozzle (6) for delivering an irrigation liquid jet (J);
rotating support means (4) associated to said launch pipe (2) to allow rotation thereof about a first substantially vertical rotation axis (X) for sprinkling at least one sector (S, S′, S″, S′″) of the soil (T) to be irrigated;
feeding means (3) for feeding said conduit (3) with a liquid flow having predetermined pressure (P) and flow rate (Q) for delivering the jet (J) having a range (g);
first adjustment means (8) for adjusting the feeding pressure (P) to vary the flow rate (Q) and the range (g) of the jet (J) upon rotation of said launch pipe (2) about said first axis (X); and
sensor means (10) configured to detect a flow rate value (Q) into said conduit (3) and to transduce said flow rate value in an electric signal (E) to be sent to said first adjustment means (8).

2. The irrigator as claimed in claim 1, wherein said first adjustment means (8) comprise a programmable logic unit (11) having a memory circuit (12) for storing thereon data (D), which relate to parameters of the sector (S, S′, S″, S′″) to be irrigated, to the flow rate (Q) of the flow to be delivered, and to a relative distance (d) of each portion (U) of said sector (S, S′, S″, S′″) from said nozzle (6) such to optimize distribution of the liquid.

3. The irrigator as claimed in claim 2, wherein said first adjustment means (8) are configured to receive said electric signal (E) and to control said feeding means (7) to produce a flow having flow rate (Q) and range (g) substantially corresponding to the data (D) stored in said memory circuit (12).

4. The irrigator as claimed in claim 2, further comprising second adjustment means (15) for adjusting the range (g) of the flow issued from said nozzle (6), said second adjustment means (5) being operatively connected to said programmable logic unit (11) to adjust said range (g) as a function of the distance (d) of the portion (U) to be irrigated.

5. The irrigator as claimed in claim 4, wherein said support means (4) comprise a flange (13) for anchoring said pipe (2) to a fixed or movable part of an irrigation system, said launch pipe (2) having at least one end portion (2′) hinged to said flange (13) for rotating about a second rotation axis (Y) substantially orthogonal to said first axis (X).

6. The irrigator as claimed in claim 5, wherein said hinged end portion (2′) is inclined with respect to a substantially horizontal plane (π) with a predetermined inclination angle (α), said second adjustment means (15) being designed to adjust said inclination angle (α).

7. The irrigator as claimed in a claim 6, wherein said second adjustment means (15) comprise a linear actuator (16) acting along a main axis (Z) and having an end (16′) fixedly attached relative to said flange (13) and a movable end (16″) connected with said hinged end portion (2′) of said launch pipe (2) to adjust said inclination angle (α).

8. The irrigator as claimed in claim 7, wherein said hinged end portion (2′) is connected to said flange (13) by a flexible tubular length (17).

9. The irrigator as claimed in claim 1, further comprising third adjustment means (23) associated with said nozzle (6) for adjusting the flow rate (Q) of the jet (J).

10. The irrigator as claimed in claim 9, wherein said third adjustment means (23) comprise an annular wall (24) of said nozzle (6) having a predetermined inner diameter (φ) for emitting a flow with a predetermined flow rate (Q) and at least one elastically yielding portion (28) configured to progressively and automatically change between a first undeformed condition and a second condition with a maximum deformation in correspondence, respectively, of a minimum value and maximum value of the pressure (P) of the flow into said conduit (3).
